(19) United States
(12) Patent Application Publication
(10) Pub. No.: US 2022/0187799 A1
(43) Pub. Date: Jun. 16, 2022

(54) MAINTAINING DEVICE SETTINGS OF A WIRELESS DEVICE AFTER A FACTORY DEFAULT RESET OPERATION

(71) Applicant: ARRIS Enterprises LLC, Suwanee, GA (US)

(72) Inventor: Ju Li, Shenzhen, Guangdong (CN)

(21) Appl. No.: 17/274,246

(22) PCT Filed: Feb. 26, 2020
(86) PCT No.: PCT/CN2020/076718

§ 371 Date: Mar. 8, 2021

(51) Int. Cl. G05B 19/418

(52) U.S. Cl. CPC G05B 19/4185; G05B 19/4183; G05B 19/41845

(57) ABSTRACT

An apparatus, system, method, and computer-readable recording medium maintain device settings for a wireless device after a factory default reset operation. A settings mode is invoked that provides options for selecting device settings for the wireless device. One or more device settings for the wireless device are selected to be set as persistent device settings, and the persistent device setting are stored in a memory. After the one or more device settings for the wireless device are set as persistent device settings, the persistent device settings will remain unchanged from a previous value after the factory default reset operation is performed on the wireless device.

### TECHNICAL FIELD

The subject matter of the present disclosure relates generally to maintaining device settings for a wireless device.

### BACKGROUND

Wireless networks for providing services to client devices or end devices via a modem/gateway device are prevalent in many homes and businesses. However, sometimes there can be problems with the operation of the modem/gateway device that interrupt services. For example, the modem/gateway device can stop working or exhibit glitches that cause the interruptions in services. Under these conditions, the user may be required to perform a reset of the modem/gateway device to the original factory default settings (e.g., hard reset) to correct the problem and restore the proper operation of the modem/gateway device.

However, a reset of the factory default settings of the modem/gateway device can cause the loss of previously set device settings (e.g., a wireless service set identifier (SSID) and password). Thus, after the reset of factory default settings of the cable modem/gateway device, the user is required to create and remember new device settings (e.g., SSID and password), which can take time and take away from the user's experience.

Thus, it would be advantageous and an improvement over the relevant technology to provide an apparatus, system, method, and computer-readable recording medium capable of maintaining previously set device settings for the modem/gateway device after a reset or factory default restore operation is performed on a modem/gateway device.

### SUMMARY

An embodiment of the present disclosure provides a method for maintaining device settings for a wireless device after a factory default reset operation. The method includes invoking, from a user interface, a settings mode. The settings mode provides options for selecting device settings for the wireless device.

The method further includes selecting, from a graphical user interface (GUI), one or more device settings for the wireless device to be set as persistent device settings; and storing, in a memory, the persistent device settings selected. The invoking of the settings mode includes executing a predetermined pressing sequence using one or more physical buttons on the wireless device, or making a selection on a mobile device connected to the wireless device. The storing of the persistent device settings selected can be in the wireless device, and the one or more device settings set as persistent device settings may include, among other device settings, a wireless service set identifier (SSID) and password. After the one or more device settings for the wireless device are set as persistent device settings, the settings mode is terminated. Each persistent device setting will remain unchanged from a previous value after the factory default reset operation is performed on the wireless device.

In an embodiment of the present disclosure, the method also includes invoking the factory default reset operation for the wireless device, and resetting all factory default settings for the wireless device except for the persistent device settings. The invoking of the factory default reset operation for the wireless device includes pressing a physical button on the wireless device or making a selection on the mobile device connected to the wireless device.

An embodiment described in present disclosure provides a modem/gateway device capable of maintaining device settings after a factory default reset operation. The modem/gateway device includes a user interface; a GUI, a hardware processor; and a non-transitory memory configured to store one or more programs. The hardware processor executes the one or more programs to: invoke a settings mode using the user interface; select using the GUI one or more device settings for the wireless device to be set as persistent device settings; and store in the non-transitory memory the persistent device settings selected and terminate the settings mode. Each persistent device setting remains unchanged from a previous value after the factory default reset operation is performed on the wireless device.

The user interface includes one or more physical buttons, and the settings mode is invoked after pressing the one or more physical buttons using a predetermined pressing sequence. The GUI includes a selection for the settings mode, and the settings mode can be invoked by selecting the settings mode from the GUI using a mobile device connected to the modem/gateway device. Additionally, the user interface may include a physical button, and the factory default reset operation is invoked after pressing the physical button.

An embodiment described in the present disclosure provides a system capable of maintaining device settings after a factory default reset operation. The system includes a modem/gateway device with a user interface, a GUI, a hardware processor, a non-transitory memory storing one or more programs, and a network interface. The system also includes a mobile device including a user interface, a hardware processor, a non-transitory memory storing one or more programs, and a network interface; and a network connection configured to establish a wireless network connection with the network interface of mobile device and the network interface of the modem/gateway device.

The respective hardware processors of the modem/gateway device and the mobile device execute their respective one or more programs to cause the system to: invoke a settings mode using the user interface of the modem/gateway device, the settings mode providing options for selecting device settings for the wireless device; select using the mobile device connected to the GUI of the modem/gateway device, one or more device settings for the wireless device to be set as persistent device settings; and store in the non-transitory memory of the modem/gateway device the persistent device settings selected and terminate the settings mode. Each persistent device setting remains unchanged from a previous value after the factory default reset operation is performed on the wireless device.

An embodiment described in the present disclosure provides a non-transitory computer-readable recording medium for maintaining devices settings on a wireless device after a factory default reset operation. The non-transitory computer-readable recording medium storing one or more programs which when executed by a hardware processor performs steps of the methods described above.

### BRIEF DESCRIPTION OF THE DRAWINGS

In the drawings, like reference numbers generally indicate identical, functionally similar, and/or structurally similar elements.

FIG. 1 is a schematic diagram of a system according to an embodiment of the present disclosure;

FIG. 2 is a more detailed schematic diagram of a modem/gateway device and mobile device according to an embodiment of the present disclosure;

FIGS. 3A and 3B are exemplary user interfaces according to embodiments of the present disclosure;

FIG. 4 is method and algorithm for maintaining device settings for a wireless device after a factory default reset operation according to an embodiment of the present disclosure; and

FIG. 5 is a method and algorithm for performing a factory default reset while maintaining device settings for a wireless device according to an embodiment of the present disclosure.

### DETAILED DESCRIPTION

The following detailed description is made with reference to the accompanying drawings and is provided to assist in a comprehensive understanding of various example embodiments of the present disclosure. The following description includes various details to assist in that understanding, but these are to be regarded as merely examples. Accordingly, those of ordinary skill in the art will recognize that various changes and modifications of the examples described herein can be made without departing from the spirit and scope of the present disclosure. In addition, descriptions of well-known functions and constructions may be omitted for clarity and conciseness.

The terms and words used in the following description and claims are merely used to enable a clear and consistent understanding of the present disclosure. Accordingly, it should be apparent to those skilled in the art that the following description of the present disclosure is provided for illustration purposes only, and not for the purpose of limiting the present disclosure as defined by the appended claims and their equivalents.

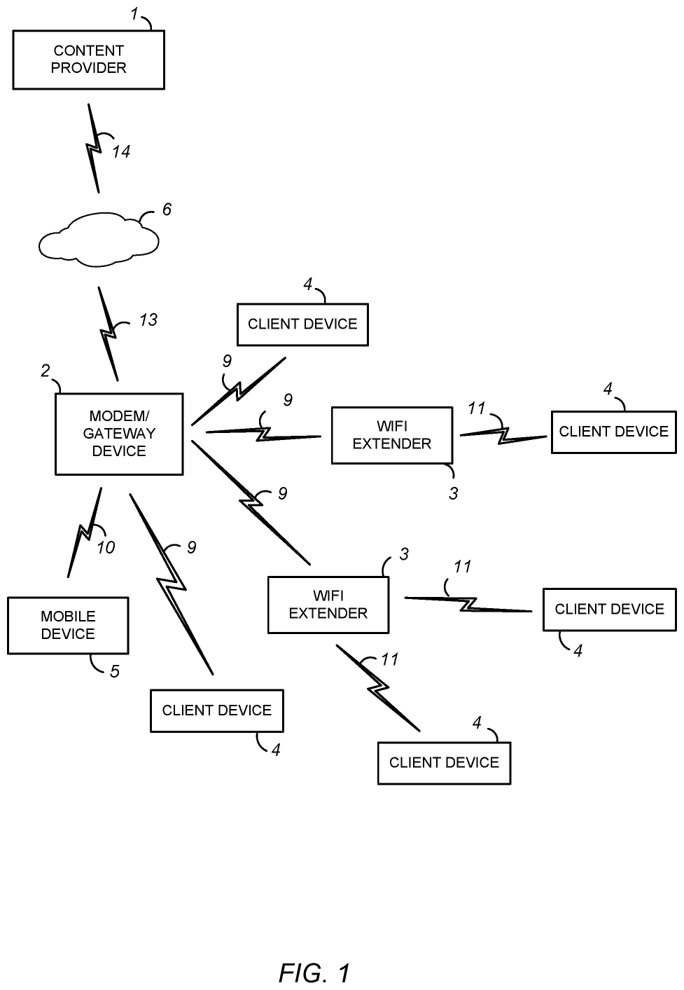

FIG. 1 is a schematic diagram of a system according to an embodiment of the present disclosure. As shown in FIG. 1, the main elements of the system includes a modem/gateway device 2 connected to a content provider 1 via the Internet 6 and also connected to different wireless devices such as client devices 4 and wireless extenders 3. Additionally, the modem/gateway device 2 is connected, for example, wirelessly to a mobile device 5.

The system shown in FIG. 1 includes wireless devices (e.g., extenders 3, client devices 4, and mobile device 5) that may be connected in one or more wireless networks (e.g., private, guest, iControl, backhaul network, or Internet of things (IoT) networks) within the system. Additionally, there could be some overlap between devices in the different networks. That is, one or more network devices could be located in more than one network. For example, wireless extenders 3 could be located both in a private network for providing content and information to a client device and also included in a backhaul network.

Starting from the top of FIG. 1, the content provider 1 may be a cable television provider, a satellite television provider, an internet service provider, or multiple system operators. The connection 14 between the Internet 6 and the content provider 1 can be implemented using a wide area network (WAN), a virtual private network (VPN), metropolitan area networks (MANs), system area networks (SANs), a public switched telephone network (PTSA), a global Telex network, or a 2G. 3G, 4G or 5G network. The connection 13 between the modem/gateway device 2 and the Internet 6 can be implemented using a digital subscriber line (DSL), a coaxial cable connection, a broadband mobile phone network connection, an optical network connection, or other similar connections. The connection 13 can also be implemented using a wireless connection that operates in accordance with, but is not limited to, IEEE 802.11 protocol, a Radio Frequency For Consumer Electronics (RF4CE) protocol, ZigBee protocol, Z-Wave protocol, or IEEE 802.15.4 protocol. It is also contemplated by the present disclosure that connection 13 is capable of providing connections between the modem/gateway device 2 and a WAN, a LAN, a VPN, MANs, PANs, WLANs, SANs, a PTSA, a global Telex network, or a 2G, 3G, 4G or 5G network.

The modem/gateway device 2 is a hardware electronic device that performs the function of a stand-alone cable modem or a combination modem and gateway device that combines the functions of a modem and a router for providing content received from the content provider 1 to network devices (e.g., client devices, wireless extenders, and mobile device) in the system. It is also contemplated by the present disclosure that the modem/gateway device 2 can include the function of, but is not limited to, an Internet Protocol/Quadrature Amplitude Modulator (IP/QAM) set-top box (STB) or smart media device (SMD) that is capable of decoding audio/video content, and playing over-the-top (OTT) or multiple system operator (MSO) provided content.

The connection 9 between the modem/gateway device 2 and the wireless extenders 3 and client devices 4 can be implemented using a wireless connection in accordance with Bluetooth protocols (e.g., Bluetooth versions 1.0-3.0 and Bluetooth Low Energy (BLE) versions 4.0-5.0) or other short range protocols that operate in accordance with a wireless technology standard for exchanging data over short distances using short-wavelength UHF radio waves from 2.4 to 2.485 GHz.

Additionally, the connection 9 can be implemented using a wireless connection that operates in accordance with, but is not limited to, IEEE 802.11 protocol, RF4CE protocol, ZigBee protocol, Z-Wave protocol, or IEEE 802.15.4 protocol. It is also contemplated by the present disclosure that the connections 9 can include connections to a media over coax (MoCA) network.

The client devices 4 can be, for example, a hand-held computing device, a personal computer, an electronic tablet, a smart phone, smart speakers, an IoT device, an iControl device, or other similar wireless hand-held consumer electronic device capable of executing and displaying the content received through, for example, the modem/gateway device 2.

The wireless extenders 3 are hardware electronic devices that are used to extend the wireless network by receiving the signals transmitted by the modem/gateway device 2 and rebroadcasting the signals to client devices 4, which may out of range of the modem/gateway device 2. The wireless extenders 3 can also receive signals from the client devices 4 and rebroadcast the signals to the modem/gateway device 2, mobile device 5, or other client devices 4.

The connection 11 between the wireless extenders 3 and the client devices 4 are implemented through a wireless connection that operates in accordance with Bluetooth protocols (e.g., Bluetooth versions 1.0-3.0 and Bluetooth Low Energy (BLE) versions 4.0-5.0) or other short range protocols that operate in accordance with a wireless technology standard for exchanging data over short distances using short-wavelength UHF radio waves from 2.4 to 2.485 GHz. Additionally, the connection 11 can be implemented using a wireless connection that operates in accordance with, but is not limited to, IEEE 802.11 protocol, RF4CE protocol, ZigBee protocol, Z-Wave protocol, or IEEE 802.15.4 protocol.

The mobile device 5 can be, for example, a hand-held computing device, a personal computer, a smartphone, an electronic tablet, an e-reader, a personal digital assistant (PDA), or a portable music player with smart capabilities that is capable of connecting to the Internet, cellular networks, and interconnect with other devices via Wi-Fi and Bluetooth protocols. The connection 10 between the modem/gateway device 2 and the mobile device 5 is implemented through a wireless connection that operates in accordance with, but is not limited to, IEEE 802.11 protocol. The connection 10 can also be implemented using a wireless connection in accordance with Bluetooth protocols (e.g., Bluetooth versions 1.0-3.0 and Bluetooth Low Energy (BLE) versions 4.0-5.0) or other short range protocols that operate in accordance with a wireless technology standard for exchanging data over short distances using short-wavelength UHF radio waves from 2.4 to 2.485 GHz. Additionally, the connection 10 between the modem/gateway device 2 and the mobile device 5 can also be implemented through a WAN, a LAN, a VPN, MANs, PANs, WLANs, SANs, a PTSA, a global Telex network, or a 2G, 3G, 4G or 5G network.

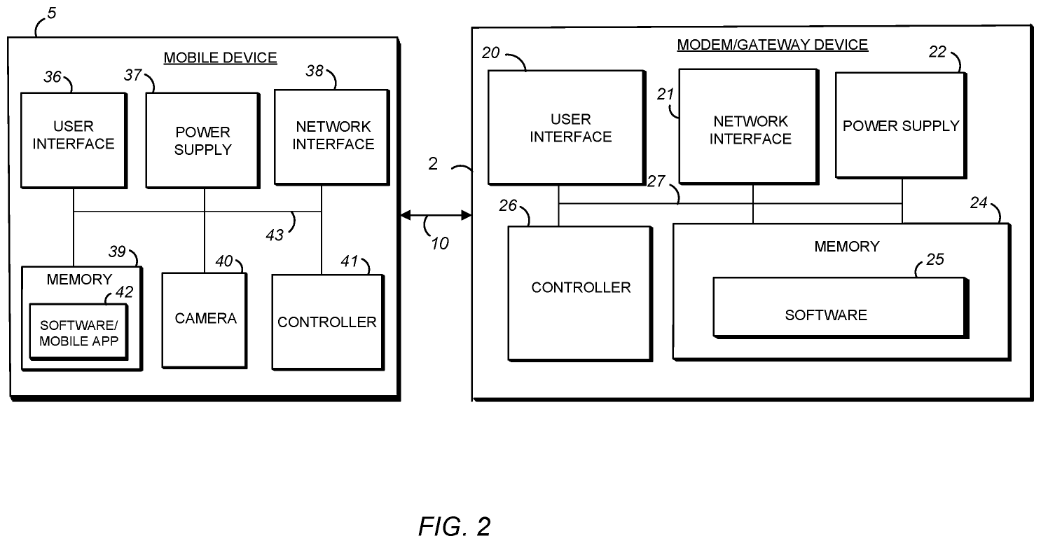

A detailed description of the exemplary internal components of the modem/gateway device 2 and mobile device 5 shown in FIG. 1 will be provided in the discussion of FIG. 2. However, in general, it is contemplated by the present disclosure that the modem/gateway device 2, the extenders 3, the client devices 4, and the mobile device 5 include electronic components or electronic computing devices operable to receive, transmit, process, store, and/or manage data and information associated with the system, which encompasses any suitable processing device adapted to perform computing tasks consistent with the execution of computer-readable instructions stored in a memory or a computer-readable recording medium.

Further, any, all, or some of the computing devices in the modem/gateway device 2, the extenders 3, the client devices 4, and the mobile device 5 may be adapted to execute any operating system, including Linux, UNIX, Windows, MacOS, DOS, and ChromOS as well as virtual machines adapted to virtualize execution of a particular operating system, including customized and proprietary operating systems. The modem/gateway device 2, the client device 4, the extenders 3, and mobile device 5 are further equipped with components to facilitate communication with other computing devices over the one or more network connections to local and wide area networks, wireless and wired networks, public and private networks, and any other communication network enabling communication in the system.

FIG. 2 illustrates a more detailed schematic diagram of an exemplary modem/gateway device 2 and the mobile device 5 in the system of FIG. 1 capable of maintaining device settings for a wireless device after a factory default reset operation according to an embodiment of the present disclosure. Although FIGS. 1 and 2 only show one mobile device 5, it is contemplated by the present disclosure that there could be more than one mobile device 5 and the mobile device 5 in FIGS. 1 and 2 is meant to be representative of the one or more mobile devices 5 that can be implemented in the system.

Now referring to FIG. 2 (e.g., from left to right), the mobile device 5 can be, for example, a hand-held computing device, a personal computer, a smartphone, an electronic tablet, an e-reader, a personal digital assistant (PDA), or a portable music player with smart capabilities that is capable of connecting to the Internet, cellular networks, and interconnect with other devices via Wi-Fi and Bluetooth. As shown in FIG. 2, the mobile device 5 includes a user interface 36, a power supply 37, a network interface 38, a memory 39, a camera 40, and a controller 41. The user interface 36 includes, but is not limited to, one or more physical buttons, one or more virtual buttons, a keyboard, a keypad, a liquid crystal display (LCD), cathode ray tube (CRT), thin film transistor (TFT), light-emitting diode (LED), high definition (HD) or other similar display device including a display device having touch screen capabilities so as to allow interaction between a user and the mobile device 5. The power supply 37 supplies power to the internal components of the mobile device 5 through the internal bus 43. The power supply 37 includes a self-contained power source such as a battery pack with an interface to be powered through an electrical charger connected to an outlet (e.g., either directly or by way of another device). The power supply 37 can also include a rechargeable battery that can be detached allowing for replacement such as a nickel-cadmium (NiCd), nickel metal hydride (NiMH), a lithium-ion (Li-ion), or a lithium Polymer (Li-pol) battery.

The network interface 38 includes various network cards, interfaces, and circuitry implemented in software and/or hardware to enable communications with the modem/gateway device 2 using connection 10. The various network cards, interfaces, and circuitry enable communications via connection 10 using a wireless connection that operates in accordance with, but is not limited to, IEEE 802.11 protocol as well as a wireless connection that operates in accordance with Bluetooth protocols (e.g., Bluetooth versions 1.0-3.0 and Bluetooth Low Energy (BLE) versions 4.0-5.0) or other short range protocols that operate in accordance with a wireless technology standard for exchanging data over short distances using short-wavelength UHF radio waves from 2.4 to 2.485 GHz. The connection 10 between the modem/gateway device 2 and the mobile device 5 using the network interface 38 can also be implemented through the Internet, a computer network, a WAN, a LAN, a VPN, MANs, PANs, WLANs, SANs, a PTSA, a global Telex network, or a 2G 3G, 4G or 5G network.

The memory 39 includes a single memory or one or more memories or memory locations that include, but are not limited to, a random access memory (RAM), dynamic random access memory (DRAM) a memory buffer, a hard drive, a database, an erasable programmable read only memory (EPROM), an electrically erasable programmable read only memory (EEPROM), a read only memory (ROM), a flash memory, logic blocks of a field programmable gate array (FPGA), hard disk or any other various layers of memory hierarchy.

The memory 39 can be used to store any type of instructions and software including software or mobile applications 42 associated with algorithms, processes, or operations for controlling the general functions and operations of the mobile device 5 for maintaining device settings for a modem/gateway device 2 after a factory default reset operation in accordance with the embodiments described in the present disclosure. The camera 40 is a standard camera of a camera phone that is able to capture photographs and record video.

The controller 41 controls the general operations of the mobile device 5 and includes, but is not limited to, a central processing unit (CPU), a hardware microprocessor, a multi-core processor, a single core processor, a field programmable gate array (FPGA), a microcontroller, an application specific integrated circuit (ASIC), a digital signal processor (DSP), or other similar processing device capable of executing any type of instructions, algorithms, or software for controlling the operation and performing the functions of the mobile device 5 in accordance with the embodiments described in the present disclosure. General communication between the components (e.g., 36-41) of the mobile device 5 is performed using the internal bus 43.

The modem/gateway device 2 is a hardware electronic device that performs the function of a stand-alone cable modem or a combination modem and gateway device that combines the functions of a modem and a router for providing content received from the content provider 1 to network devices (e.g., client devices, wireless extenders, and mobile device) in the system. It is also contemplated by the present disclosure that the modem/gateway device 2 can include the function of, but is not limited to, an Internet Protocol/Quadrature Amplitude Modulator (IP/QAM) set-top box (STB) or smart media device (SMD) that is capable of decoding audio/video content, and playing over-the-top (OTT) or multiple system operator (MSO) provided content.

As shown in FIG. 2, the modem/gateway device 2 includes a user interface 20, a network interface 21, a power supply 22, a memory 24, and a controller 26. The user interface 20 includes, but is not limited to, one or more physical buttons, one or more virtual buttons, a keyboard, a keypad, a graphical user interface (GUI) an LCD, a CRT, a TFT, an LED, an HD or other similar display device including a display device having touch screen capabilities so as to allow interaction between a user and the modem/gateway device 2. The network interface 21 includes various network cards, and circuitry implemented in software and/or hardware to enable communications with the client devices 4 and WiFi extenders 3 using connection 9 and with the mobile device using connection 10.

The various network cards, interfaces, and circuitry of the network interface 21 enable communications via connection 9 using a wireless protocol in accordance with, but is not limited to, Bluetooth protocols (e.g., Bluetooth versions 1.0-3.0 and Bluetooth Low Energy (BLE) versions 4.0-5.0) or other short range protocols that operate in accordance with a wireless technology standard for exchanging data over short distances using short-wavelength UHF radio waves from 2.4 to 2.485 GHz. Additionally, the various network cards, interfaces, and circuitry of the network interface 21 enable communications via connection 9 using a wireless connection that operates in accordance with, but is not limited to, IEEE 802.11 protocol, RF4CE protocol, ZigBee protocol, Z-Wave protocol, or IEEE 802.15.4 protocol.

The various network cards, interfaces, and circuitry of the network interface 21 enable communications via connection 10 to the mobile device 5 using a wireless protocol that operates in accordance with, but is not limited to, IEEE 802.11 protocol as well as wireless protocol in accordance with, but is not limited to, Bluetooth protocols (e.g., Bluetooth versions 1.0-3.0 and Bluetooth Low Energy (BLE) versions 4.0-5.0) or other short range protocols that operate in accordance with a wireless technology standard for exchanging data over short distances using short-wavelength UHF radio waves from 2.4 to 2.485 GHz. The connection 10 between the modem/gateway device 2 and the mobile device 5 using the network interface 21 can also be through the Internet, a computer network, a WAN, a LAN, a VPN, MANs, PANs, WLANs, SANs, a PTSA, a global Telex network, or a 2G, 3G, 4G or 5G network.

The power supply 22 supplies power to the internal components of the modem/gateway device 2 through the internal bus 27. The power supply 22 can be a self-contained power source such as a battery pack with an interface to be powered through an electrical charger connected to an outlet (e.g., either directly or by way of another device). The power supply 22 can also include a rechargeable battery that can be detached allowing for replacement such as a NiCd, a NiMH, a Li-ion, or a Li-pol battery.

The memory 24 includes a single memory or one or more memories or memory locations that include, but are not limited to, a RAM, a DRAM, a memory buffer, a hard drive, a database, an EPROM, an EEPROM, a ROM, a flash memory, logic blocks of a FPGA, hard disk or any other various layers of memory hierarchy. The memory 24 can be used to store any type of instructions or software including software 25 associated with algorithms, processes, or operations for controlling the general functions and operations of the modem/gateway device 2 for maintaining device settings after a factory default reset operation in accordance with the embodiments described in the present disclosure.

The controller 26 controls the general operations of the modem/gateway device 2 and includes, but is not limited to, a CPU, a hardware microprocessor, a multi-core processor, a single core processor, a FPGA, a microcontroller, an ASIC, a DSP, or other similar processing device capable of executing any type of instructions, algorithms, or software for controlling the operation and performing the functions of the modem/gateway device 2 in accordance with the embodiments described in the present disclosure. Communication between the components (e.g., 20-22, 24, and 26) of the modem/gateway device 2 is established using the internal bus 27.

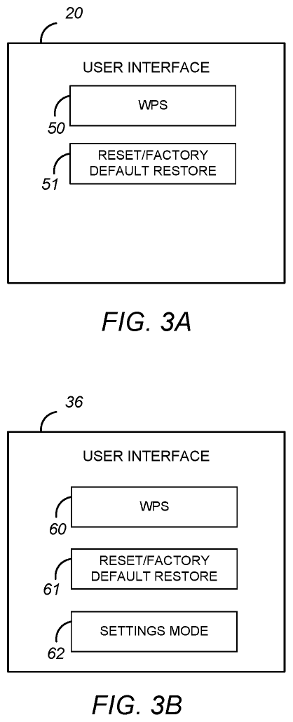

FIGS. 3A and 3B illustrate exemplary user interfaces according to embodiments of the present disclosure.

As shown in FIG. 3A, the user interface 20 of the modem/gateway device 2 may include physical buttons 50, 51. As shown in FIG. 3A, the buttons include a wireless protected setup (WPS) button 50, and a reset/factory default restore button 51. It is contemplated by the present disclosure that the WPS button 50 can be used to initiate a WPS process for connecting a WPS-enabled device (e.g., client device 4 or extender 3) to a wireless network (e.g., a private network) in the system. The wireless networks of the system are established, effected, or hosted by the modem/gateway device 2. Additionally, the reset/factory default restore button 51 can be used to perform a reset or factory default restore operation (i.e., hard reset) of the device settings for the modem/gateway device 2. There may be occasions when a user needs to reset the cable modem/gateway device 2 to the factory default settings. For example, if the user forgets or loses a username and password, or if cable modem/gateway device 2 stops working or is not working properly.

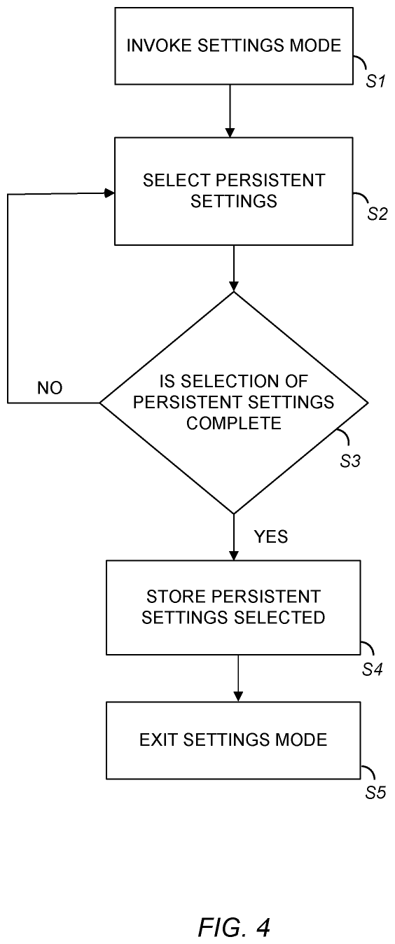

The reset or factory default will generally restore proper operation of the modem/gateway device 2, but will reset the previously set device settings to the factory default settings. By implementing the methods and algorithms of FIG. 4 and the user interface of FIG. 3A, the user is able to maintain selected device settings such as, but not limited to, the SSID and password even after the reset or factory default restore operation. For example, by using a predetermined pressing sequence of the WPS button 50 and/or the reset or factory default restore button 51, the user can initiate or invoke a settings mode. For example, the user can press the WPS button 50 while pressing the reset or factory default restore button 51, or the user can press either the WPS button 50 or factory default restore button 51 for a predetermined amount of time (e.g., 30 seconds or longer).

Once the settings mode is invoked, the user will be presented with options for selecting device settings for the modem/gateway device 2 that can be selected as persistent device settings. For example, the user can select, among other device settings, a current SSID and password as persistent device settings. Once set, the persistent device settings will remain unchanged from a current value after a factory default reset operation is performed on the wireless device.

As shown in FIG. 3B, the user interface 36 of the mobile device 5 may include the use, for example, virtual buttons or selection options 60-62. As shown in FIG. 3B, the virtual buttons or selection options 60-62 include a WPS button or selection 60, a reset/factory default restore button or selection 61, and a settings mode button or selection 62. The buttons or selections 60-62 of the mobile device 5 can be implemented in combination with a graphical user interface (GUI) of the modem/gateway device 2. That is, the user can connect to the GUI of the modem/gateway device 2 using a browser of the mobile device 5 and the address of the modem/gateway device (e.g., http:192.168.0.1). In the alterative, the user can connect to the GUI of the modem/gateway device 2 using software or a mobile application 42 stored in the mobile device 5. Once connected to the modem/gateway device 2, the user of the mobile device can be presented with the virtual buttons or selection options 60-62. The WPS button or selection 60 can be used to initiate a WPS process for connecting a WPS-enabled device (e.g., client device 4 or extender 3) to a wireless network (e.g., a private network). Additionally, the reset/factory default restore button or selection 61 can be implemented to perform a reset or factory default restore operation of all the device settings for the modem/gateway device 2. The settings mode button or selection 62 can be used to select and initiate or invoke the settings mode.

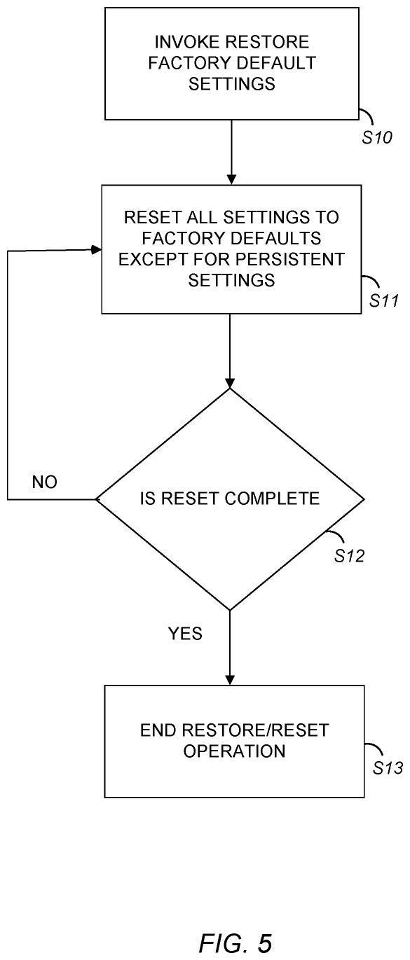

Once the settings mode is invoked, the user would be presented with options for selecting device settings for the modem/gateway device 2 that can be selected as persistent device settings (e.g., the user can select a current SSID and password as persistent device settings as well as other device settings). Once set, the persistent device settings will remain unchanged from their current values after the factory default reset operation is performed on the wireless device. The details of setting and maintaining the persistent device settings are described in detail with reference to FIGS. 4 and 5.

FIG. 4 is method and algorithm for maintaining device settings for a wireless device after a factory default reset operation according to an embodiment of the present disclosure.

In FIG. 4, the method and algorithm illustrate exemplary operations performed by, the example, the software 25 executed by the controller 26 of the modem/gateway device 2 when a user invokes the settings mode from the user interface 20 shown in FIG. 3A. The method and algorithm of FIG. 4 also illustrate exemplary operations performed by the software or mobile application 42 executed by the controller 41 of the mobile device 5 when a user invokes the settings mode from the user interface 36 shown in FIG. 3B.

In step S1, the user invokes the settings mode on the modem/gateway device 2. Using the user interface 20 of FIG. 3A, the user can implement a predetermined pressing sequence of the physical WPS button 50 and/or the reset or factory default restore button 51 to initiate or invoke a settings mode. For example, the user can press the WPS button 50 while pressing the reset or factory default restore button 51, or the user can press either the WPS button 50 or factory default restore button 51 for a predetermined amount of time (e.g., 30 seconds or longer). Please note that the pressing sequence to initiate or invoke the settings mode can be modified and/or be varied by, for example, reprogramming the modem/gateway device 2. Additionally, the user can also select a settings mode button or selection 62 or other similar selection option presented from the GUI of the modem/gateway device 2. That is, the user can connect to the GUI of the modem/gateway device 2 using a browser of the mobile device 5 and the address of the modem/gateway device (e.g., http:192.168.0.1). In the alterative, the user can connect to the GUI of the modem/gateway device 2 using software or a mobile application 42 stored in the mobile device 5.

Once the settings mode is invoked, the user would be presented with options for selecting device settings for the modem/gateway device 2 that can be selected as persistent device settings. For example, the user can be presented with a menu, table, or other similar configuration of device settings from the GUI of the modem/gateway device 2 that can be selected as persistent device settings for the modem/gateway device 2. In step S2, the user would select one or more device settings that are to remain as persistent device settings. For example, the user can select, among other device settings, a current WiFi SSID and password as persistent device settings. Other device settings that can be selected as persistent device settings include, but are not limited to, parental controls, firewall levels, and other security and configuration settings for the modem/gateway device 2. Once set as persistent device settings, the device settings will remain unchanged from their current value even after a factory default reset operation is performed on the modem/gateway device 2.

In step S3, it is determined if the user is done with his/her selection of persistent values. If the user is not done with his/her selection of persistent values, the user can continue to make the selection of one or more device settings that are to remain as persistent values, as in step S2. However, if the user is done with his/her selection of persistent values, the user can store the selected persistent values in a memory location 24 of the modem/gateway device 2 in step S4. Once the persistent values are selected and stored, the user can exit the setting modes and disconnect from the GUI of the modem/gateway device 2 in step S5.

FIG. 5 is a method and algorithm for performing a factory default reset while maintaining device settings for a wireless device according to an embodiment of the present disclosure.

In FIG. 5, the method and algorithm illustrate exemplary operations performed by, for example, the software 25 executed by the controller 26 of the modem/gateway device 2 when a user invokes a restore factory default settings operation from the user interface 20 shown in FIG. 3A. The method and algorithm of FIG. 5 also illustrate exemplary operations performed, for example, by the software or mobile application 42 executed by the controller 41 of the mobile device 5 when a user invokes a restore factory default settings operation from the user interface 36 shown in FIG. 3B.

In steps S10, the user invokes a restore factory default settings operation via the user interface 20 of the modem/gateway device 2 (e.g., as shown in FIG. 3A) or via the user interface 36 of the mobile device (e.g., as shown in FIG. 3B). For example, when implementing the user interface 20 in FIG. 3A, the user would push, for example, the physical reset/factory default restore button 51. When implementing the user interface 36 in FIG. 4B, the user would select the factory default restore button or selection 61 or other similar selection option presented from the GUI of the modem/gateway device 2. That is, the user can connect to the GUI of the modem/gateway device 2 using a browser of the mobile device 5 and the address of the modem/gateway device (e.g., http:192.168.0.1). In the alterative, the user can connect to the GUI of the modem/gateway device 2 using software or a mobile application 42 stored in the mobile device 5.

Based on the pressing or selection of the buttons or selections 51, 61, the software 25 executed by the controller 26 of the modem/gateway device 2 would initiate a reset or factory default restore operation of the device settings for the modem/gateway device in step S11. There may be occasions when a user needs to reset the cable modem/gateway device 2 to the factory defaults, for example, if the user forgets or loses a username and password, or if cable modem/gateway device 2 stops working or is not working properly and requires a hard reset.

In step S12, it is determined if the reset or factory default restore operation is complete. If the reset or factory default restore operation it not complete, the operation will continue, as in step S11. If the reset or factory default restore is complete, then all the device settings for the modem/gateway device 2 will be reset to the original factory default settings except for the device settings selected and stored as persistent values by the user (e.g., as in FIG. 4). After the reset or factory default restore is complete, the operation will ends in step S13.

Using the methods and algorithms for implementing the selection and maintaining of persistent values (e.g., in FIGS. 4 and 5) of a modem/gateway device 2, the user can maintain any number of selected device settings of the modem/gateway device 2 after a reset or factory default restore operation is performed on the modem/gateway device 2. For example, the user can perform a reset or factory default restore operation to restore proper operation of the modem/gateway device 2 while maintaining the WiFi SSID and password that was previously set. Therefore, the user can avoid having to create and remember a new WiFi SSID and password after a reset or factory default restore operation is performed, thereby improving a user's experience.

The present disclosure may be implemented as any combination of an apparatus, a system, an integrated circuit, and a computer program on a non-transitory computer readable recording medium. The one more processors may be implemented as an integrated circuit (IC), an application specific integrated circuit (ASIC), or large scale integrated circuit (LSI), system LSI, super LSI, or ultra LSI components that perform a part or all of the features of the embodiments described in the present disclosure.

The present disclosure includes the use of software, applications, computer programs, or algorithms. The software, applications, computer programs, or algorithms can be stored on a non-transitory computer-readable medium for causing a computer, such as the one or more processors, to execute the steps described in FIGS. 4 and 5. For example, the one or more memories stores software or algorithms with executable instructions and the one or more processors can execute a set of instructions of the software or algorithms in association the performing the features of the embodiments described in the present disclosure.

The software and computer programs, which can also be referred to as programs, software applications, applications, components, or code, include machine instructions for a programmable processor, and can be implemented in a high-level procedural language, an object-oriented programming language, a functional programming language, a logical programming language, or an assembly language or machine language. The term computer-readable recording medium refers to any computer program product, apparatus or device, such as a magnetic disk, optical disk, solid-state storage device, memory, and programmable logic devices (PLDs), used to provide machine instructions or data to a programmable data processor, including a computer-readable recording medium that receives machine instructions as a computer-readable signal.

By way of example, a computer-readable medium can comprise DRAM, RAM, ROM, EEPROM, CD-ROM or other optical disk storage, magnetic disk storage or other magnetic storage devices, or any other medium that can be used to carry or store desired computer-readable program code in the form of instructions or data structures and that can be accessed by a general-purpose or special-purpose computer, or a general-purpose or special-purpose processor. Disk or disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

Use of the phrases “capable of,” “capable to,” “operable to,” or “configured to” in one or more embodiments, refers to some apparatus, logic, hardware, and/or element designed in such a way to enable use of the apparatus, logic, hardware, and/or element in a specified manner. The subject matter of the present disclosure is provided as examples of apparatus, systems, methods, and programs for performing the features of the embodiments described in the present disclosure. However, further features or variations are contemplated in addition to the features described above. It is contemplated that the implementation of the components and functions of the present disclosure can be done with any newly arising technology that may replace any of the above implemented technologies.

Additionally, the above description provides examples, and is not limiting of the scope, applicability, or configuration set forth in the claims. Changes may be made in the function and arrangement of elements discussed without departing from the spirit and scope of the disclosure. Various embodiments may omit, substitute, or add various procedures or components as appropriate. For instance, features described with respect to certain embodiments may be combined in other embodiments.

We claim:

1. A method for maintaining device settings for a wireless device after a factory default reset operation, the method comprising:
invoking, from a user interface, a settings mode, the settings mode providing options for selecting device settings for the wireless device;
selecting, from a graphical user interface (GUI), one or more device settings for the wireless device to be set as persistent device settings; and
storing, in a memory, the persistent device settings selected and terminating the settings mode,
wherein the persistent device settings will remain unchanged from a previous value after the factory default reset operation is performed on the wireless device.

2. The method according to claim 1, further comprising:
invoking the factory default reset operation for the wireless device; and
resetting all factory default settings for the wireless device except for the persistent device settings.

3. The method according to claim 1, wherein the invoking of the settings mode includes executing a predetermined pressing sequence using one or more physical buttons on the user interface of the wireless device.

4. The method according to claim 1, wherein the invoking of the settings mode includes making a selection using a mobile device connected to the wireless device.

5. The method according to claim 2, wherein the invoking of the factory default reset operation for the wireless device includes pressing a physical button on the wireless device or making a selection using a mobile device connected to the wireless device.

6. The method according to claim 1, wherein the selecting of the persistent device settings is performed using a mobile device connected to the GUI of wireless device.

7. The method according to claim 1, wherein the storing of the persistent device settings selected is in the wireless device.

8. The method according to claim 1, wherein the one or more device settings set as persistent device settings include a wireless service set identifier (SSID) and password.

9. A non-transitory computer-readable recording medium for maintaining devices settings on a wireless device after a factory default reset operation, the non-transitory computer-readable recording medium storing one or more programs which when executed by a hardware processor performs steps comprising:
invoking a settings mode, the settings mode providing options for selecting device settings for the wireless device;
selecting one or more device settings for the wireless device to be set as persistent device settings; and
storing the persistent device settings selected, and terminating the settings mode,
wherein the persistent device settings will remain unchanged from a previous value after a factory default reset operation is completed.

10. The non-transitory computer-readable recording medium according to claim 9, wherein the one or more programs when executed by the hardware processor perform steps further comprising:
invoking the factory default reset operation for the wireless device; and
resetting all factory default settings for the wireless device except for the persistent device settings.

11. The non-transitory computer-readable recording medium according to claim 9, wherein the invoking of the settings mode includes executing a predetermined pressing sequence using one or more physical buttons on a user interface of the wireless device.

12. The non-transitory computer-readable recording medium according to claim 9, wherein the invoking of the settings mode includes making a selection using a mobile device connected to the wireless device.

13. The non-transitory computer-readable recording medium according to claim 10, wherein the invoking of the factory default reset operation for the wireless device includes pressing a physical button on the wireless device or making a selection using a mobile device connected to the wireless device.

14. The non-transitory computer-readable recording medium according to claim 9, wherein the selecting of the persistent device settings is performed using a mobile device connected to a graphical user interface of wireless device.

15. A modem/gateway device capable of maintaining device settings after a factory default reset operation comprising:
a user interface;
a graphical user interface (GUI);
a hardware processor; and
a non-transitory memory configured to store one or more programs,
wherein the hardware processor executes the one or more programs to:
invoke a settings mode using the user interface, the settings mode providing options for selecting device settings for the wireless device;
select using the GUI one or more device settings for the wireless device to be set as persistent device settings; and
store in the non-transitory memory the persistent device settings selected and terminate the settings mode,
wherein the persistent device settings will remain unchanged from a previous value after the factory default reset operation is performed on the modem/gateway device.

16. The modem/gateway device according to claim 15, wherein
the user interface includes one or more physical buttons, and
the settings mode is invoked after pressing the one or more physical buttons using a predetermined pressing sequence.

17. The modem/gateway device according to claim 15, wherein
the GUI includes a selection for the settings mode, and
the settings mode is invoked by selecting the settings mode from the GUI using a mobile device connected to the modem/gateway device.

18. The modem/gateway device according to claim 15, wherein
the user interface includes a physical button, and
the factory default reset operation is invoked after pressing the physical button on the user interface.

19. The modem/gateway device according to claim 15, wherein the one or more device settings set as persistent device settings include a wireless service set identifier (SSID) and password.
